(19) United States
(12) Patent Application Publication
(10) Pub. No.: US 2006/0256248 A1
(43) Pub. Date: Nov. 16, 2006

(54) Thin film transistor array panel and method thereof

(76) Inventors: Seung-soo Baek, Seoul (KR); Dong-gyu Kim, Yongin-si (KR); Ae Shin, Suwon-si (KR)

Correspondence Address: CANTOR COLBURN, LLP, 55 GRIFFIN ROAD SOUTH, BLOOMFIELD, CT, 06002, US

(21) Appl. No.: 11/409,589

(22) Filed: Apr. 24, 2006

(30) Foreign Application Priority Data
May 16, 2005 (KR) 10-2005-0040757

(51) Int. Cl. G02F 1/136

(52) U.S. Cl. 349/42

(57) ABSTRACT

A thin film transistor (TFT) array panel for maintaining uniform parasitic capacitance occurring in individual pixels is provided. The thin film transistor array panel includes a gate line having a gate electrode disposed on an insulating substrate and extending in a row direction, a semiconductor layer disposed above and insulated from the gate electrode, a data line having a source electrode that at least partially overlaps with the semiconductor layer, the data line extending in a column direction, crossing the gate line, and insulated from the gate line, a drain electrode facing the source electrode around the gate electrode, at least partially overlapping with the semiconductor layer, and crossing over the gate electrode, and a pixel electrode disposed above and insulated from the resulting structure, the pixel electrode electrically connected to the drain electrode and divided into a plurality of small domains by a domain divider.

This application claims priority to Korean Patent Application No. 10-2005-0040757, filed on May 16, 2005 and all the benefits accruing therefrom under 35 U.S.C. §119, and the contents of which in its entirety are herein incorporated by reference.

### BACKGROUND OF THE INVENTION

1. Field of the Invention

The present invention relates to a thin film transistor (“TFT”) array panel and method thereof. More particularly, the present invention relates to a TFT array panel preventing flickering and increasing picture quality of a display containing the TFT array panel, and a method for reducing flickering in a display panel.

2. Description of the Related Art

A TFT array panel is used as a circuit substrate that independently drives each pixel in a liquid crystal display (“LCD”) or an organic light emitting display (“OLED”). In the TFT array panel, a gate line transmitting a scan signal and a data line transmitting an image signal cross each other, thereby defining a pixel between adjacent pairs of gate lines and data lines, at which a TFT connected to the gate line and the data line and a pixel electrode connected to the TFT are formed.

The TFT includes a part of the gate line, i.e., a gate electrode, a semiconductor layer forming a channel, a part of the data line, i.e., a source electrode and a drain electrode, and a gate insulating layer. The TFT is a switching element that transmits or interrupts the image signal transmitted through the data line to the pixel electrode according to the scan signal transmitted through the gate line.

While the resolution and area of an LCD have increased, elements used for the LCD tend to be light, thin, simple, and small. To accomplish high resolution, it is necessary to elongate a data line and a gate line. In this situation, when an overlay is different between layers in manufacturing a TFT array panel, the electrical characteristics of individual pixels may be different.

Generally, it is necessary to overlap a gate electrode and a drain electrode, which are included in a TFT, with each other in a TFT array panel due to a processing margin of photolithography, a process used to transfer a pattern from an optic mask to a layer of resist deposited on the surface, where the optic mask blocks resist exposure to UV radiation in selected areas. Conventionally, the gate electrode and the drain electrode overlap with each other by about 1-2 μm. Accordingly, in such a TFT, parasitic capacitance always exists.

When an overlay error occurs between data lines vertically or horizontally arranged on the basis of a gate line in a conventional TFT array panel, the amount of overlap between a gate electrode and a drain electrode becomes different between pixels. As a result, parasitic capacitance is not uniform among the pixels. When the parasitic capacitance of each pixel radically changes throughout the TFT array panel, a kickback voltage becomes different and flickering increases, thereby decreasing the picture quality of a display containing the TFT array panel.

In addition, since a width/length (W/L) characteristic of a switching element is different between pixels, the visibility of the TFT array panel may decrease due to a difference in an electrical characteristic between switching elements.

Moreover, when an overlay error occurs between a gate or data line and a pixel electrode, parasitic capacitance between the gate or data line and the pixel electrode is not uniform among pixels. In this case, flickering also increases, and therefore, the visibility of a display containing the TFT array panel may decrease.

### BRIEF SUMMARY OF THE INVENTION

The present invention provides a thin film transistor (“TFT”) array panel for maintaining uniform parasitic capacitance occurring in individual pixels.

This and other features and advantages of the present invention will become clear to those skilled in the art upon review of the following description.

According to exemplary embodiments of the present invention, there is provided a TFT array panel including a gate line, a semiconductor layer, a data line, a drain electrode, and a pixel electrode. The gate line is disposed on an insulating substrate, extends in a row direction, and has a gate electrode. The semiconductor layer is disposed above and insulated from the gate electrode. The data line has a source electrode that at least partially overlaps with the semiconductor layer, the data line also extends in a column direction to cross the gate line, and is insulated from the gate line. The drain electrode faces the source electrode around the gate electrode, at least partially overlaps with the semiconductor layer, and crosses over the gate electrode. The pixel electrode is disposed above and insulated from the resulting structure including the gate line, the semiconductor layer, and the data line, is electrically connected to the drain electrode, and is divided into a plurality of small domains by a domain divider.

According to other exemplary embodiments of the present invention, there is provided an thin film transistor array panel including a gate line disposed on an insulating substrate, extending in a row direction, and having a gate electrode, a semiconductor layer disposed above and insulated from the gate electrode; a data line having a source electrode that at least partially overlaps with the semiconductor layer, the data line extending in a column direction to cross the gate line and being insulated from the gate line; a drain electrode facing the source electrode around the gate electrode and at least partially overlapping with the semiconductor layer, a pixel electrode disposed above and insulated from the resulting structure, the pixel electrode being electrically connected to the drain electrode and being divided into a plurality of small domains by a domain divider, and a floating electrode disposed above and insulated from the gate line and the floating electrode at least partially overlapping with the gate line.

According to still other exemplary embodiments of the present invention, there is provided a thin film transistor array panel including a gate line disposed on an insulating substrate, extending in a row direction, and having a gate electrode; a semiconductor layer disposed above and insulated from the gate electrode; a data line having a source electrode at least partially overlapping with the semiconductor layer, the data line extending in a column direction to cross the gate line and being insulated from the gate line; a drain electrode facing the source electrode around the gate electrode and at least partially overlapping with the semiconductor layer; a pixel electrode disposed above and insulated from the resulting structure including the gate line, the semiconductor layer, and the data line, the pixel electrode being electrically connected to the drain electrode and being divided into a plurality of small domains by a domain divider, and a floating electrode disposed above and insulated from the data line and the floating electrode at least partially overlapping with the data line.

According to other exemplary embodiments of the present invention, a method of reducing flickering in a display panel includes maintaining uniform parasitic capacitance in a thin film transistor array panel of the display panel even if a distance between adjacent pixel electrodes and a data line or a gate line interposed between the pixel electrodes is not constant.

### BRIEF DESCRIPTION OF THE DRAWINGS

The above and other features and advantages of the present invention will become more apparent by describing in detail preferred embodiments thereof with reference to the attached drawings in which:

FIG. 1 is a block diagram of an exemplary embodiment of a liquid crystal display (“LCD”) including a thin film transistor (“TFT”) array panel according to the present invention;

FIG. 2 is an equivalent circuit diagram for two exemplary pixels in the LCD shown in FIG. 1;

FIG. 3 is an equivalent circuit diagram of the exemplary TFT array panel shown in FIG. 1;

FIG. 4A is a layout of a first exemplary embodiment of a TFT array panel according to the present invention;

FIG. 4B is a cross section of the exemplary TFT array panel, taken along line IVb-IVb′ shown in FIG. 4A;

FIG. 4C is a layout of an exemplary color filter panel disposed above the exemplary TFT array panel shown in FIG. 4A;

FIG. 4D illustrates a layout when the exemplary color filter panel shown in FIG. 4C is superimposed on the exemplary TFT array panel shown in FIG. 4A;

FIGS. 5A through 5D are cross sections of sequential stages in an exemplary embodiment of a method of manufacturing the exemplary TFT array panel shown in FIG. 4A;

FIG. 6A is a layout of a second exemplary embodiment of a TFT array panel according to the present invention;

FIG. 6B is a cross section of the exemplary TFT array panel, taken along line VIb-VIb′ shown in FIG. 6A;

FIG. 6C is an equivalent circuit diagram illustrating parasitic capacitances among a pixel electrode, a floating electrode, and a gate line included in the exemplary TFT array panel shown in FIG. 6A;

FIG. 6D illustrates a modified example of the exemplary TFT array panel shown in FIG. 6A;

FIG. 7A is a layout of a third exemplary embodiment of a TFT array panel according to the present invention;

FIG. 7B is a cross section of the exemplary TFT array panel, taken along line VIIb-VIIb′ shown in FIG. 7A;

FIG. 8A is a layout of a fourth exemplary embodiment of a TFT array panel according to the present invention;

FIG. 8B is a cross section of the exemplary TFT array panel, taken along line VIIIb-VIIIb′ shown in FIG. 8A;

FIG. 9A is a layout of a fifth exemplary embodiment of a TFT array panel according to the present invention;

FIG. 9B is a cross section of the exemplary TFT array panel, taken along line IXb-IXb′ shown in FIG. 9A;

FIG. 10A is a layout of a sixth exemplary embodiment of a TFT array panel according to the present invention;

FIG. 10B is a cross section of the exemplary TFT array panel, taken along line Xb-Xb′ shown in FIG. 10A;

FIG. 11A is a layout of a seventh exemplary embodiment of a TFT array panel according to the present invention;

FIG. 11B is a cross section of the exemplary TFT array panel, taken along line XIb-XIb′ shown in FIG. 11A;

FIG. 12A is a layout of an eighth exemplary embodiment of a TFT array panel according to the present invention; and

FIG. 12B is a cross section of the exemplary TFT array panel, taken along line XIIb-XIIb′ shown in FIG. 12A.

### DETAILED DESCRIPTION OF THE INVENTION

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

The present invention will now be described more fully with reference to the accompanying drawings, in which preferred embodiments of the invention are shown. In the drawings, the thickness of layers, films, and regions are exaggerated for clarity. It will be understood that when an element such as a layer, film, region, or substrate is referred to as being “on” another element, it can be directly on the other element or intervening elements may also be present.

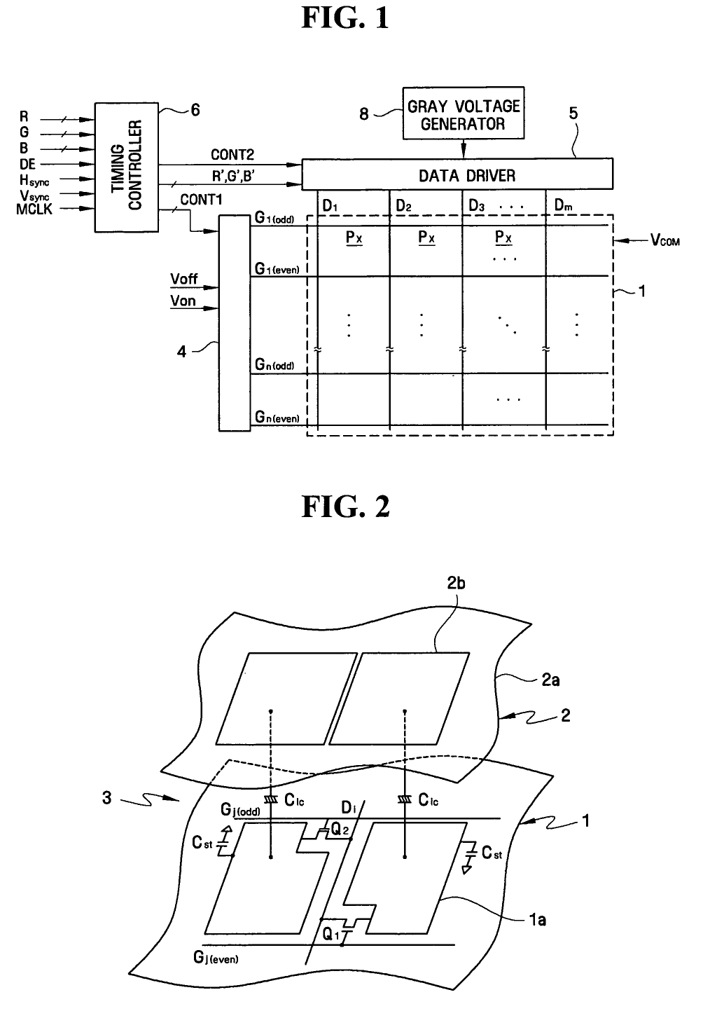

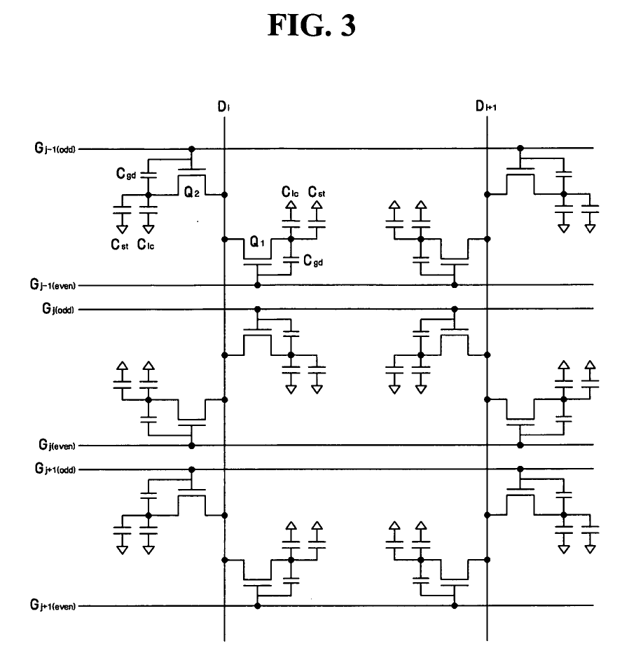

FIG. 1 is a block diagram of an exemplary embodiment of a liquid crystal display (“LCD”) including a thin film transistor (“TFT”) array panel according to the present invention, FIG. 2 is an equivalent circuit diagram for two exemplary pixels in the LCD shown in FIG. 1, and FIG. 3 is an equivalent circuit diagram of the exemplary TFT array panel shown in FIG. 1.

Referring to FIGS. 1 through 3, the LCD includes a TFT array panel 1, a gate driver 4 and a data driver 5 which are connected to the TFT array panel 1, a gray voltage generator 8 connected to the data driver 5, and a timing controller 6 controlling the other elements.

In terms of an equivalent circuit, the TFT array panel 1 includes a plurality of display signal lines G_{1(odd)}, G₁₍ₑᵥₑₙ₎, . . . , G_{n(odd)}, Gₙ₍ₑᵥₑₙ₎, D₁, . . . , Dₘ and a plurality of pixels Px which are connected to the display signal lines G_{1(odd)} through Dₘ and arranged substantially in matrix form.

The display signal lines G_{1(odd)} through Dₘ include a plurality of gate lines G_{1(odd)} through Gₙ₍ₑᵥₑₙ₎ each transmitting a gate signal, also referred to as a scanning signal, and a plurality of data lines D₁ through Dₘ each transmitting a data signal.

The gate lines G_{1(odd)} through Gₙ₍ₑᵥₑₙ₎ roughly extend in a row direction and are substantially parallel with each other. The gate lines G_{1(odd)} through Gₙ₍ₑᵥₑₙ₎ are divided into pairs, each pair including an odd signal line and an even signal line. The data lines D₁ through Dₘ roughly extend in a column direction and are substantially parallel with each other and substantially perpendicular to the gate lines G_{1(odd)} through Gₙ₍ₑᵥₑₙ₎.

For example, a plurality of gate lines G_{j-1(odd)}, Gⱼ₋₁₍ₑᵥₑₙ₎, G_{j(odd)}, Gⱼ₍ₑᵥₑₙ₎, G_{j+1(odd)}, and Gⱼ₊₁₍ₑᵥₑₙ₎ included in the TFT array panel 1 are adjacent to each other and are divided into pairs, each pair including an odd gate line and an even gate line which extend in the row direction.

Each pixel includes a switching element Q₁ or Q₂ connected to the display signal lines, e.g., the display signal lines G_{j-1(odd)} or Gⱼ₋₁₍ₑᵥₑₙ₎ and Dᵢ, and a liquid crystal capacitor C_{lc} and a storage capacitor Cₛₜ which are connected to the switching element Q₁ or Q₂.

In an alternative embodiment, the storage capacitor Cₛₜ may be omitted.

The switching elements Q₁ and Q₂ are included in the TFT array panel 1 and are three-terminal elements having gate electrodes respectively connected to a pair of odd and even gate lines, e.g., the gate electrode of the switching element Q₁ is connected to gate line G_{j-1(odd)} and the gate electrode of the switching element Q₂ is connected to gate line Gⱼ₋₁₍ₑᵥₑₙ₎. The switching elements Q₁ and Q₂ further include source electrodes commonly connected to a data line extending between the switching elements Q₁ and Q₂, e.g., the data line Dᵢ. The drain electrode of each of the switching elements Q₁ and Q₂ is connected to the liquid crystal capacitor C_{lc} and the storage capacitor Cₛₜ via the pixel electrode 1a.

The switching elements Q₁ and Q₂ are respectively positioned on the right and left sides, e.g. first and second sides, of a data line, e.g. Di. The gate electrode of the switching element Q₂ positioned on the left side of the data line Di is connected to an odd gate line, e.g. G_{j-1(odd)}, in a pair of odd and even gate lines. The gate electrode of the switching element Q₁ positioned on the right side of the data line Di is connected to an even gate line, e.g. Gⱼ₋₁₍ₑᵥₑₙ₎, in the pair of odd and even gate lines. With such an arrangement, a single pixel row is formed. It should be understood, however, that the present invention is not restricted to the above-described arrangement. The present invention can also be used, for example, for a TFT array panel including a data line extending to provide a pair of source electrodes to a pair of pixel electrodes arranged in the row direction when gate lines extend in the row direction. For example, the present invention can be used for a TFT array panel having a structure in which a data line extends to a pair of switching elements, which are positioned in the row direction beside the data line, to form source electrodes of the respective switching elements. Here, the odd gate lines G_{1(odd)} through G_{n(odd)} respectively pair with the even gate lines G₁₍ₑᵥₑₙ₎ through Gₙ₍ₑᵥₑₙ₎. Each pair of the odd and even gate lines transmit a gate signal to a pair of source electrodes.

In addition, the source electrodes of the respective switching elements Q₁ and Q₂ positioned on the right and left sides of a single data line are connected to each other, thereby forming a single pixel column.

The liquid crystal capacitor C_{lc} has a pixel electrode 1a of the TFT array panel 1 as a first terminal and a common electrode 2a of a color filter panel 2 as a second terminal. A liquid crystal layer 3 disposed between the two electrodes 1a and 2a functions as a dielectric. The pixel electrode 1a is connected to the drain electrode of the switching element Q₁ or Q₂. The common electrode 2a is formed on the entire surface, or substantially the entire surface, of the color filter panel 2 and is supplied with a common voltage V_{com}. In an alternative embodiment, the common electrode 2a may be included in the TFT array panel 1, in which at least one of the two electrodes 1a and 2a are formed in a line or bar shape.

The storage capacitor Cₛₜ may be formed when a separate signal line (not shown), of the TFT array panel 1, is overlapped with the pixel electrode 1a, where the overlapped portion becomes the storage capacitor Cₛₜ. The separate signal line may be supplied with a fixed voltage such as the common voltage V_{com}. Alternatively, the storage capacitor Cₛₜ may be formed when the pixel electrode 1a is overlapped with a gate line, such as a previous gate line, with an insulator interposed therebetween.

An additional capacitor C_{gd} may be formed between the gate electrode and the drain electrode of each of the switching elements Q₁ and Q₂.

Meanwhile, to accomplish color display, each pixel needs to be made to display color by providing a red, green, or blue color filter 2b in an area corresponding to the pixel electrode 1a. In other embodiments, the filters 2b may be provided in alternative color combinations. Referring to FIG. 2, the color filter 2b is formed in a corresponding area on the color filter panel 2. Alternatively, the color filter 2b may be formed above or below the pixel electrode 1a on the TFT array panel 1.

A polarizer (not shown), which polarizes light, is attached to an outside of at least one of the TFT array panel 1 and the color filter panel 2. When a first polarized film and a second polarized film are disposed on the TFT array panel 1 and the color filter panel 2, respectively, the first and second polarized films adjust a transmission direction of light externally provided into the TFT array panel 1 and the color filter panel 2, respectively, in accordance with an aligned direction of the liquid crystal layer 3. The first and second polarized films have first and second polarized axes thereof substantially perpendicular to each other.

The gray voltage generator 8 generates two pairs of gray voltages relating to the brightness of the LCD and related with the transmittance of a pixel. One pair of voltages has a positive value with respect to the common voltage V_{com} and the other pair of voltages has a negative value with respect to the common voltage V_{com}. The gray voltage generator 8 provides the gray voltages to the data driver 5. The data driver 5 applies the gray voltages, which are selected for each data line, by control of the timing controller 6, to the data line respectively as a data signal.

The gate driver 4 is connected to the gate lines G_{1(odd)} through Gₙ₍ₑᵥₑₙ₎ of the TFT array panel 1 and supplies gate signals formed by combining an external gate-on voltage Von and an external gate-off voltage Voff to the gate lines G_{1(odd)} through Gₙ₍ₑᵥₑₙ₎.

The data driver 5 is connected to the data lines D₁ through Dₘ of the TFT array panel 1. The data driver 5 selects a gray voltage received from the gray voltage generator 8 and supplies the gray voltage as a data signal to pixels via the data lines D₁ through Dₘ. The data driver 5 is usually implemented with a plurality of integrated circuits.

The timing controller 6 generates control signals for controlling the operations of the gate driver 4 and the data driver 5 and provides the control signals to the gate driver 4 and the data driver 5.

The following describes in detail the display operation of the LCD having the above-described structure.

The timing controller 6 receives from an external graphic controller (not shown) red, green, and blue video signals R, G, and B and input control signals, for example, a vertical synchronizing signal V_{sync}, a horizontal synchronizing signal H_{sync}, a main clock signal MCLK, and a data enable signal DE, for controlling the display of the video signals R, G, and B. The timing controller 6 generates a gate control signal CONT1 and a data control signal CONT2 based on the input control signals, processes the video signals R, G, and B appropriately to the operating conditions of the TFT array panel 1, transmits the gate control signal CONT1 to the gate driver 4, and transmits the data control signal CONT2 and the processed video data R′, G′, and B′ to the data driver 5.

The gate control signal CONT1 includes a vertical synchronizing start signal (STV) as a scanning start signal for informing the beginning of a frame and having instructions to start outputting a gate-on pulse (i.e., a gate-on voltage period), at least one gate clock signal (CPV) controlling an output time of the gate-on pulse, and an output enable signal (OE) for defining the duration and limiting the width of the gate-on pulse.

The data control signal CONT2 includes a horizontal synchronizing start signal (STH) having instructions to start inputting the video data R′, G′, and B′, a load signal (LOAD) having instructions to load a corresponding data voltage to the data lines D₁ through Dₘ, a reverse signal (RVS) reversing the polarity of the data voltage with respect to the common voltage V_{com} (hereinafter, referred to as “the polarity of the data voltage”), and a data clock signal (HCLK).

The data driver 5 sequentially receives the video data R′, G′, and B′ corresponding to a row of pixels according to the data control signal CONT2 from the timing controller 6, selects a gray voltage corresponding to each video data R′, G′, and B′ from among gray voltages received from the gray voltage generator 8, and converts the video data R′, G′, and B′ into data voltages, and then applies the data voltages to the data lines D₁ through Dₘ.

The gate driver 4 supplies a gate-on voltage Von having a period of (½)H to the gate lines G_{1(odd)} through Gₙ₍ₑᵥₑₙ₎ according to the vertical synchronizing start signal (STV) and the gate clock signal (CPV) received from the timing controller 6 to turn on the switching elements Q₁ and Q₂ connected to the gate lines G_{1(odd)} through Gₙ₍ₑᵥₑₙ₎. The unit “1H” is equal to one period of the horizontal synchronizing signal H_{sync}, the data enable signal DE, and the gate clock signal CPV.

While the switching elements Q₁ and Q₂ are turned on by the gate-on voltage Von supplied to the gate lines G_{1(odd)} through Gₙ₍ₑᵥₑₙ₎ and thus to the gate electrodes, the data driver 5 respectively supplies data voltages to the data lines D₁ through Dₘ. The data voltages supplied to the data lines D₁ through Dₘ are respectively supplied to the pixels through the turned-on switching elements Q₁ and Q₂ via their source electrodes and drain electrodes.

The arrangement of liquid crystal molecules within the LC layer 3 changes according to the change of an electrical field generated by the pixel electrode 1a and the common electrode 2a, thereby changing polarization of light transmitted by the liquid crystal layer 3. Such polarization change results in the change of light transmittance due to the polarizer attached to at least one of the TFT array panel 1 and the color filter panel 2. The difference between the data voltage applied to the pixel and the common voltage V_{com} is represented as a charged voltage across the LC capacitor C_{LC}, namely, a pixel voltage. The LC molecules in the LC layer 3 have orientations depending on the magnitude of the pixel voltage.

With such operations, the gate-on voltage Von is sequentially supplied to all of the gate lines G_{1(odd)} through Gₙ₍ₑᵥₑₙ₎ during a single frame period so that the data voltages are supplied to all of the pixels. After one frame ends, a subsequent frame starts and the reverse signal (RVS), part of the data control signals CONT2, applied to the data driver 5 is controlled to reverse the polarity of the data voltage supplied to each pixel with respect to that of a previous frame (which is referred to as frame inversion). Here, within a single frame, according to the characteristics of the reverse signal (RVS), the polarity of the data voltage supplied through one data line may change (which is referred to as line inversion) or the polarities of a data voltage supplied to a single row of pixels may be different from each other (which is referred to as dot inversion).

In a pixel arrangement on the TFT array panel 1 according to the present invention, since a data voltage is supplied to a pair of pixels through a single data line, the number of data lines is reduced by half. Meanwhile, however, the number of gate lines doubles. Here, the size of the TFT array panel 1 can be prevented from increasing by integrating the gate driver 4 that supplies the gate signals to the gate lines G_{1(odd)} through Gₙ₍ₑᵥₑₙ₎ into one or both sides of the TFT array panel 1.

Accordingly, the present invention doubles the number of pixels in the same screen size, thereby accomplishing a resolution two times higher than a resolution of conventional technology.

Hereinafter, various embodiments of a TFT array panel used for the LCD shown in FIGS. 1 through 3 will be described.

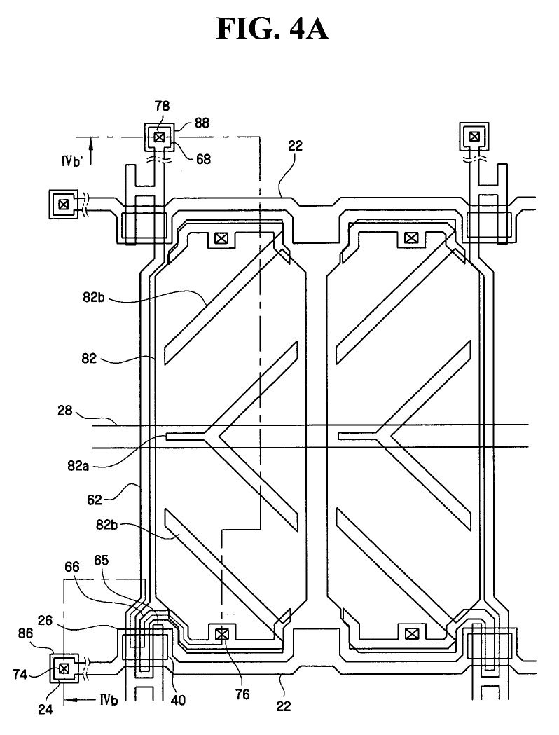

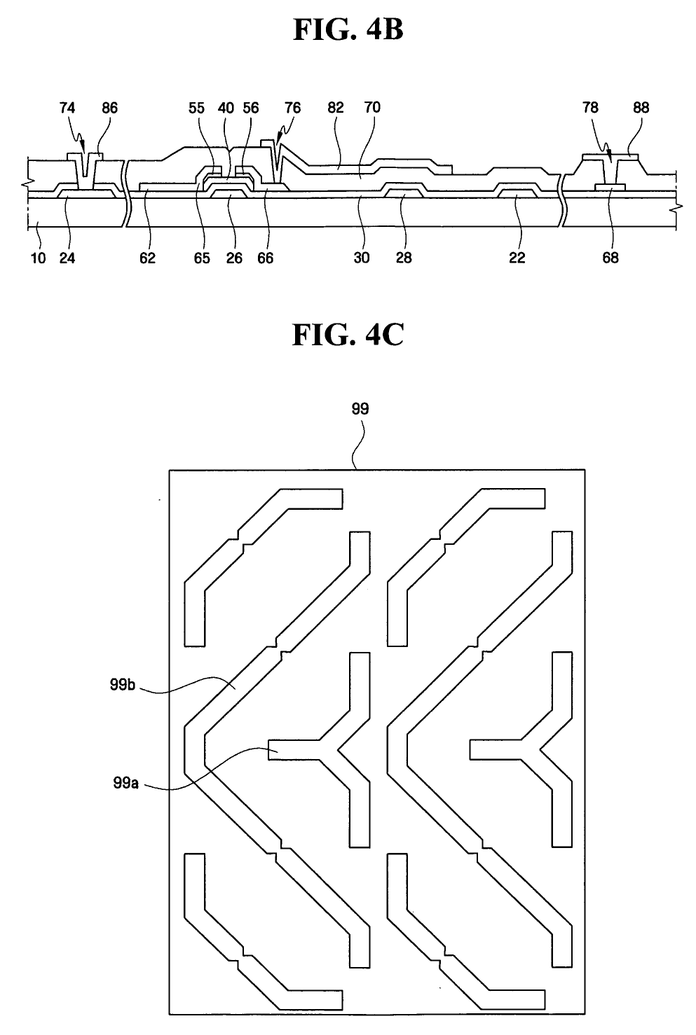

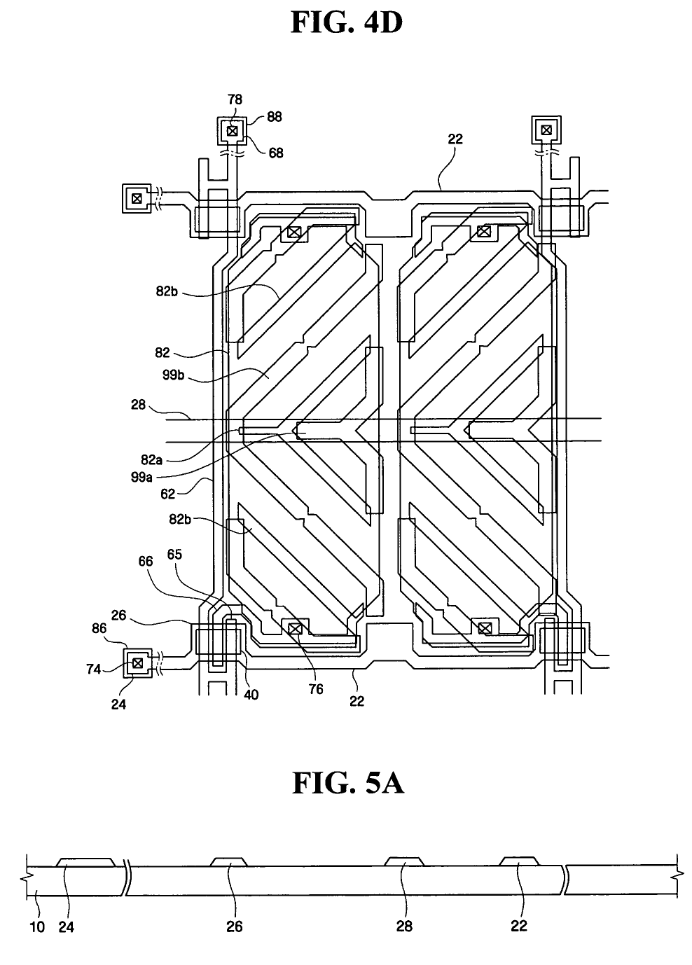

A first exemplary embodiment of the structure of a TFT array panel according to the present invention will be described below with reference to FIGS. 4A through 4D.

FIG. 4A is a layout of a first exemplary embodiment of a TFT array panel according to the present invention, FIG. 4B is a cross section of the exemplary TFT array panel, taken along line IVb-IVb′ shown in FIG. 4A, FIG. 4C is a layout of an exemplary color filter panel disposed above the exemplary TFT array panel shown in FIG. 4A, and FIG. 4D illustrates a layout when the exemplary color filter panel shown in FIG. 4C is superimposed on the exemplary TFT array panel shown in FIG. 4A.

A storage capacitance wiring 28 and a gate wiring are disposed on an insulating substrate 10. The storage capacitance wiring 28 and the gate wiring may be made using a single layer formed of aluminum Al (or Al alloy) or a dual layer with an Al (or Al alloy) layer and a molybdenum Mo (or Mo alloy) layer.

The gate wiring includes a gate line 22 extending in a latitudinal direction, such as a row direction, a gate line terminal 24 connected to an end of the gate line 22 to receive a gate signal from an exterior and transmit the gate signal to the gate line 22, and a gate electrode 26 of a TFT connected to the gate line 22.

A gate insulating layer 30 formed using silicon nitride (SiNₓ) is disposed on the substrate 10 so that the gate wiring, including gate line 22, gate line terminal 24, and gate electrode 26, and the storage capacitance wiring 28 are also covered with the gate insulating layer 30.

A semiconductor layer 40, formed using a semiconductor material such as amorphous silicon a-Si, is disposed in an island shape on a portion of the gate insulating layer 30 corresponding to the gate electrode 26. Ohmic contact layers 55 and 56 are formed of a material, for example, n+ amorphous silicon a-Si hydride on the semiconductor layer 40 by doping the semiconductor layer 40 with silicide or n-type impurities at high concentration.

A data wiring is formed on the ohmic contact layers 55 and 56 and the gate insulating layer 30. The data wiring includes a data line 62 which extends in a longitudinal direction, such as a column direction, and crosses the gate line 22 to define a pixel, a source electrode 65 which branches from the data line 62 and extends to the top of the ohmic contact layer 55, a data line terminal 68 which is connected to an end of the data line 62 and receives an image signal from an exterior, and a drain electrode 66 which is separated from the source electrode 65 and is disposed on the top of the ohmic contact layer 56 at the opposite side of the gate electrode 26 to the source electrode 65. The data line terminal 68 is wider than the data line 62 for connection with an external circuit. The data wiring including the data line 62, source electrode 65, drain electrode 66, and data line terminal 68 may have a single layer structure formed using a conductive film such as an Al (or Al alloy) or Mo (or Mo alloy) film or a multilayer structure formed using at least two conductive films.

Switching elements including the source electrode 65, the drain electrode 66, and the gate electrode 26 are respectively positioned at first and second sides of the data line 62. For example, the switching element on the left side of the data line 62 is connected to a gate electrode 26 extending from an odd gate line 22 and the switching element on the right side of the data line 62 is connected to a gate electrode 26 extending from an even gate line 22, but the present invention is not restricted thereto. The arrangement of the left and right switching elements may be changed. In addition, the present invention can also be used for a TFT array panel having a structure in which a single data line branches to respectively provide source electrodes for a pair of switching elements neighboring each other along a gate line, for example, a structure in which a pair of source electrodes extending from a single data line are respectively used as input terminals of two switching elements lined on one side, i.e., on the left or right side of a data line.

As shown in FIG. 4A, the source electrode 65 overlaps with at least a part of the semiconductor layer 40. The drain electrode 66 faces the source electrode 65 around the gate electrode 26 and also overlaps with at least part of the semiconductor layer 40. The source electrode 65 and the drain electrode 66 may be parallel with each other on the semiconductor layer 40.

The drain electrode 66 crosses over the gate electrode 26. As shown in FIG. 4A, the drain electrode 66 extends from one side of the gate electrode 26 to an opposite side of the gate electrode 26, thus completely crossing over a width of the gate electrode 26. The drain electrode 66 illustrated in FIG. 4A extends substantially parallel with a longitudinally extending portion of the data line 62. In this case, when the drain electrode 66 is formed after the gate electrode 26 is formed, the gate electrode 26 always overlaps with the drain electrode 66 even if a margin in photolithography and an overlay error are considered. Thus, an amount of overlapping between the gate electrode 26 and the drain electrode 66 is always the same between different pixels. As a result, parasitic capacitance occurring between the gate electrode 26 and the drain electrode 66 always has the same value with respect to all pixels. Because the parasitic capacitance is uniform among the pixels, picture quality of a display containing the TFT array panel 1 is maintained.

Referring back to FIG. 3, a gate voltage V_{g} from a gate line is supplied to the gate electrode of the switching element Q₁ and a data voltage V_{d} from a data line is supplied to the source electrode thereof. A first terminal of each of the storage capacitor Cₛₜ and the liquid crystal capacitor C_{lc} are connected to the drain electrode of the switching element Q₁. A storage voltage V_{cs} is supplied to a second terminal of the storage capacitor Cₛₜ and the common voltage V_{com} is supplied to a second terminal of the liquid crystal capacitor C_{lc}. When the gate voltage V_{g} is turned on, the switching element Q₁ is turned on via the gate electrode of the switching element Q₁ and the data voltage V_{d} is supplied via the source electrode of the switching element Q₁ to a pixel electrode 1a connected to the drain electrode of the switching element Q₁ so that the liquid crystal capacitor C_{lc} and the storage capacitor Cₛₜ are charged. A voltage of the pixel electrode 1a is referred to as a pixel voltage Vₚ and is a voltage actually charged in the liquid crystal capacitor C_{lc}. The polarity of the data voltage V_{d} is inverted periodically on the basis of the common voltage V_{com}. However, when the switching element Q₁ changes from ON to OFF, the gate voltage V_{g} drops rapidly and a coupling effect occurring due to a parasitic capacitance C_{gd} between the gate electrode and the drain electrode causes the voltage actually charged in the liquid crystal capacitor C_{lc} to drop by a kickback voltage Vₖ. When the amount of positive charges is not exactly equal to the amount of negative charges in the liquid crystal capacitor C_{lc} due to the kickback voltage Vₖ, the coupling effect is recognized. The kickback voltage Vₖ is expressed, using the gate voltage V_{g}, as the following equation:
Vₖ={C_{gd}/(C_{lc}+Cₛₜ+C_{gd})}×V_{g}.

The kickback voltage Vₖ is influenced by the parasitic capacitance C_{gd} between the gate electrode and the drain electrode. When the parasitic capacitance C_{gd} is different among pixels, such as what occurs when an overlay error is experienced in a conventional TFT array panel, the kickback voltage Vₖ also becomes different among the pixels, which increases the coupling effect. As a result, the picture quality of the TFT array panel decreases as a whole.

However, in a TFT array panel according to the present invention, parasitic capacitance between the gate electrode 26 and the drain electrode 66 actually has the same value among all pixels, even if an overlay error is experienced, and therefore, a coupling effect is prevented and the picture quality is uniform throughout all pixels. In particular, when the position of a switching element is different for pixels in a TFT array panel, since the drain electrode 66 crosses over the gate electrode 26, extending over and past opposite sides of the gate electrode 26, the parasitic capacitance almost does not change in each pixel even if an overlay error occurs between a gate wiring and a data wiring. In addition, since an area in which the source electrode 65 and the drain electrode 66 face each other is regular among the pixels, switching elements can be made to have the same W/L.

The drain electrode 66 may also be formed to completely cross over the semiconductor layer 40.

A protective layer 70 is disposed on the data wiring (62, 65, 66, 68) and the semiconductor layer 40 exposed through the data wiring. The protective layer 70 may be made using, for example, a SiNₓ layer, an a-Si:C:O layer, or an a-Si:O:F layer (i.e., a low-dielectric-constant chemical vapor deposition (“CVD”) layer) formed using plasma enhanced CVD (“PECVD”), an acrylic organic insulating layer, or the like. The a-Si:C:O layer and the a-Si:O:F layer formed using PECVD have a very low dielectric constant of less than 4 (specifically, a value between 2 and 4), and therefore, even if they are thin, a parasitic capacitance problem does not occur. In addition, the a-Si:C:O layer and the a-Si:O:F layer have high adhesion and step coverage. Moreover, since they are inorganic CVD layers, they have higher thermal resistance than an organic insulating layer. Since the a-Si:C:O layer and the a-Si:O:F layer have a 4-10 times faster deposition or etching speed than the SiNₓ layer, they are advantageous in terms of processing time.

Contact holes 76 and 78 are formed through the protective layer 70 to expose the drain electrode 66 and the data line terminal 68, respectively. A contact hole 74 is formed through the protective layer 70 and the gate insulating layer 30 to expose the gate line terminal 24. The contact holes 74 and 78 respectively exposing the gate line terminal 24 and the data line terminal 68 may be formed in various shapes such as, but not limited to, polygonal shapes and circular shapes.

A pixel electrode 82 is disposed on the protective layer 70 in a pixel area to be electrically connected to the drain electrode 66 through the contact hole 76. In addition, an auxiliary gate line terminal 86 and an auxiliary data line terminal 88 are disposed on the protective layer 70 to be respectively connected to the gate line terminal 24 through the contact hole 74 and to the data line terminal 68 through the contact hole 78. The pixel electrode 82 and the auxiliary gate and data line terminals 86 and 88 are made using a transparent conductive layer such as an indium tin oxide (ITO) layer or an indium zinc oxide (IZO) layer. Cut patterns may be formed in the pixel electrode 82. The cut patterns include a horizontal cut pattern 82a formed to extend in the horizontal direction, such as parallel to the gate lines 22, at a position dividing the pixel electrode 82 into an upper half and an lower half and diagonal cut patterns 82b formed in the upper and lower portions of the divided pixel electrode 82 in a diagonal direction. Here, a diagonal cut pattern 82b in the upper portion and a diagonal cut pattern 82b in the lower portion may be formed to be perpendicular to each other to uniformly disperse a fringe field in four directions. Portions of the diagonal cut pattern 82b may extend from the horizontal cut pattern 82a as shown. While a particular cut patter in the pixel electrode 82 is shown, it should be understood that alternate patterns and quantities of cuts may be varied depending on size and various other features of the display panel.

In an alternative embodiment, instead of forming the storage capacitance wiring 28 on the same level as the gate wiring (22, 24, 26), the pixel electrode 82 may be formed to overlap with the gate line 22 to form a storage capacitor.

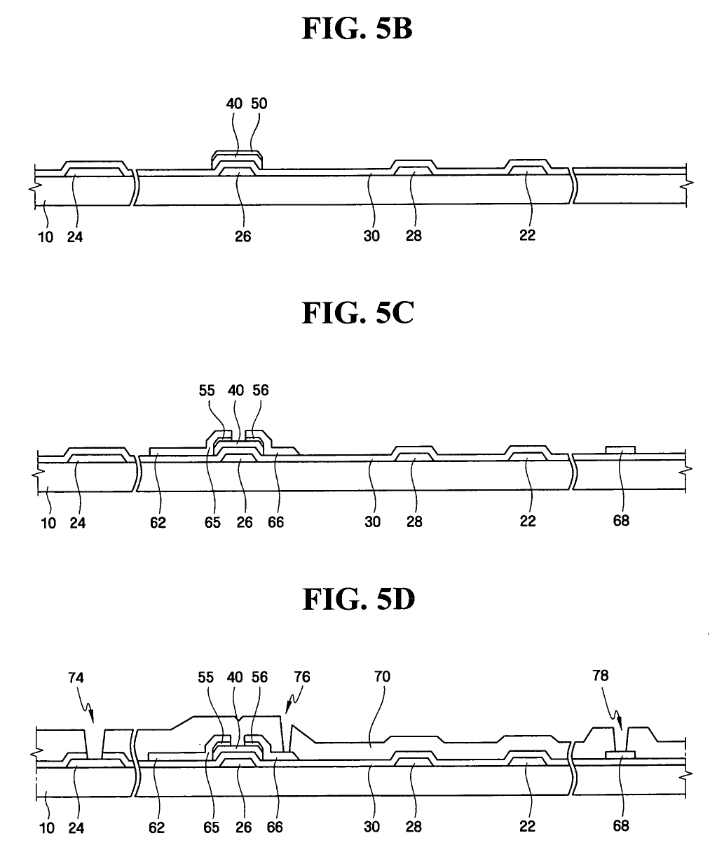

An exemplary embodiment of a method of manufacturing the first embodiment of the TFT array panel according to the present invention will be described in detail with reference to FIGS. 4A and 4B and FIGS. 5A through 5D. FIGS. 5A through 5D are cross sections of sequential stages in an exemplary method of manufacturing the exemplary TFT array panel shown in FIG. 4A.

Referring to FIG. 5A, a metal film (not shown) for a gate wiring, such as a multilayer metal film, is formed on the entire surface of an insulating substrate 10 and then patterned, thereby forming a gate wiring including a gate line 22, a gate electrode 26, and a gate line terminal 24, and a storage capacitance wiring 28 in the horizontal direction. Here, the gate wiring (22, 24, 26) and the storage capacitance wiring 28 may be made using a single Al (or Al alloy) layer or a dual layer with an Al (or Al alloy) layer and a Mo (or Mo alloy) layer.

Next, referring to FIG. 5B, a gate insulating layer 30 of silicon nitride, an a-Si layer (not shown) for a semiconductor layer, and a doped a-Si layer are sequentially stacked. Thereafter, the a-Si layer for a semiconductor layer and the doped a-Si layer are etched using photolithography, thereby forming a semiconductor layer 40 in an island shape and a doped a-Si layer pattern 50 on the gate electrode 26.

Referring to FIG. 5C, a data metal layer (not shown) is formed on the structure shown in FIG. 5B and patterned using photolithography using a mask, thereby forming a data wiring including a data line 62 crossing the gate line 22, a source electrode 65 connected to the data line 62 and extending to the top of the gate electrode 26, a data line terminal 68 connected to an end of the data line 62, and a drain electrode 66 separated from the source electrode 65 and facing the source electrode 65 around the gate electrode 26.

Thereafter, the doped amorphous silicon layer pattern 50 exposed through the data wiring (62, 65, 66, 68) is etched, thereby separately forming ohmic contact layers 55 and 56 at opposite sides of the gate electrode 26 and exposing the semiconductor layer 40 through the ohmic contact layers 55 and 56. Subsequently, oxygen plasma treatment may be performed to stabilize the surface of the exposed semiconductor layer 40.

Next, referring to FIG. 5D, a protective layer 70 is formed by growing a silicon nitride layer, an a-Si:C:O layer, or an a-Si:O:F layer using CVD or depositing an organic insulating material. Subsequently, the protective layer 70 and the gate insulating layer 30 are patterned using photolithography, thereby forming contact holes 74, 76, and 78 exposing the gate line terminal 24, the drain electrode 66, and the data line terminal 68, respectively. The contact holes 74, 76, and 78 may be formed to have, by example only, a polygonal or circular shape.

As shown in FIGS. 4A and 4B, ITO or IZO is deposited and etched using photolithography, thereby forming a pixel electrode 82 connected to the drain electrode 66 through the contact hole 76, an auxiliary gate line terminal 86 connected to the gate line terminal 24 through the contact hole 74, and an auxiliary data line terminal 88 connected to the data line terminal 68 through the contact hole 78. In a pre-heating process before the deposition of ITO or IZO, nitrogen gas may be used to prevent a metal oxide layer from being formed on the tops of the metal layers 24, 66, and 68 exposed through the contact holes 74, 76, and 78.

FIG. 4C is a layout of a color filter panel. On the entire surface, or substantially the entire surface, of the color filter panel, a common electrode 99 is formed using a material such as ITO or IZO. Cut patterns are formed in the common electrode 99. The cut patterns include horizontal cut patterns 99a some of which are formed at a position dividing the common electrode 99 into an upper half portion and a lower half portion in the horizontal direction and diagonal cut patterns 99b formed in the upper and lower half portions in diagonal directions. Diagonal cut patterns 99b in the upper half portion may be formed to be perpendicular to diagonal cut patterns 99b in the lower half portion to uniformly disperse a fringe field in four directions. Vertical cut patterns extending in a longitudinal direction may also be provided and may be connected to the diagonal cut patterns as shown. Although not shown, a black matrix for preventing light leakage and a red, green, or blue filter are formed at an area of the color filter panel corresponding to the circumference of each pixel area. Although a particular cut pattern is illustrated, it should be understood that variations in quantities of cuts and patterning of the cuts may also be provided depending on the size of the display panel and the desired effects thereof.

FIG. 4D illustrates a layout when the exemplary color filter panel shown in FIG. 4C is superimposed on the exemplary TFT array panel shown in FIG. 4A. In the superimposed layout, each diagonal cut pattern 82b of the pixel electrode 82 is positioned between adjacent diagonal cut patterns 99b of the common electrode 99.

When a TFT array panel having the above-described structure and a color filter panel having the above-described structure are arranged and coupled and then a liquid crystal material is injected therebetween in a liquid crystal layer and vertically aligned, a basic structure of an LCD is made. When the TFT array panel 1 and the color filter panel are arranged, the cut patterns 82a and 82b of the pixel electrode 82 and the cut patterns 99a and 99b of the common electrode 99 divide a pixel area into a plurality of small domains, which are classified into four types according to an average direction of long axes of liquid crystal molecules within each small domain.

As described above, an exemplary embodiment of a TFT array panel according to the present invention employs pattern vertical alignment (PVA) in which cut patterns are formed in an electrode as a means for achieving a wide viewing angle. However, the present invention is not restricted thereto and may use multi-domain vertical alignment to achieve the wide viewing angle by forming a dielectric protrusion, which will be further described.

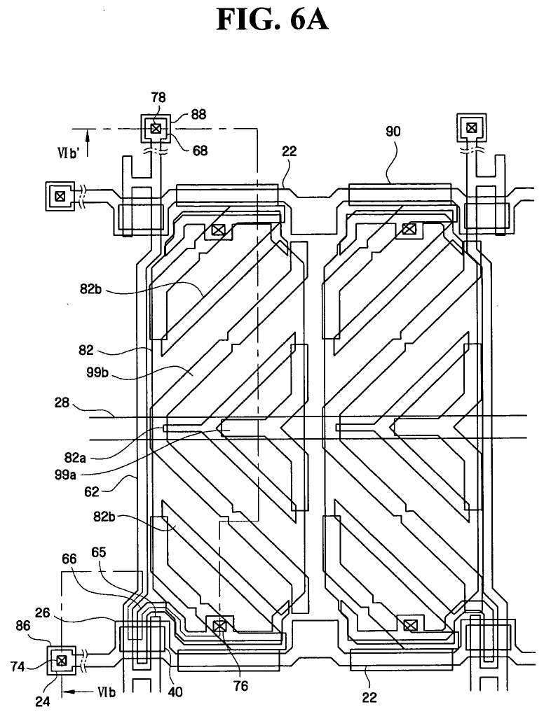

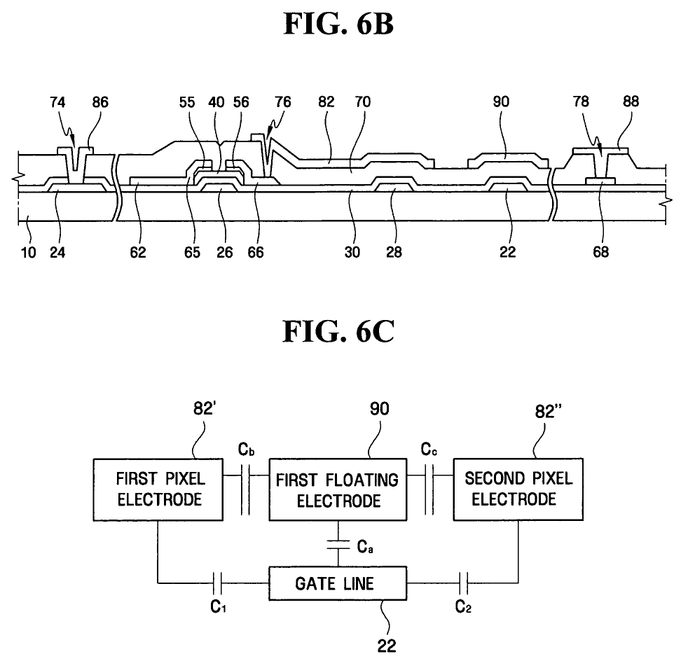

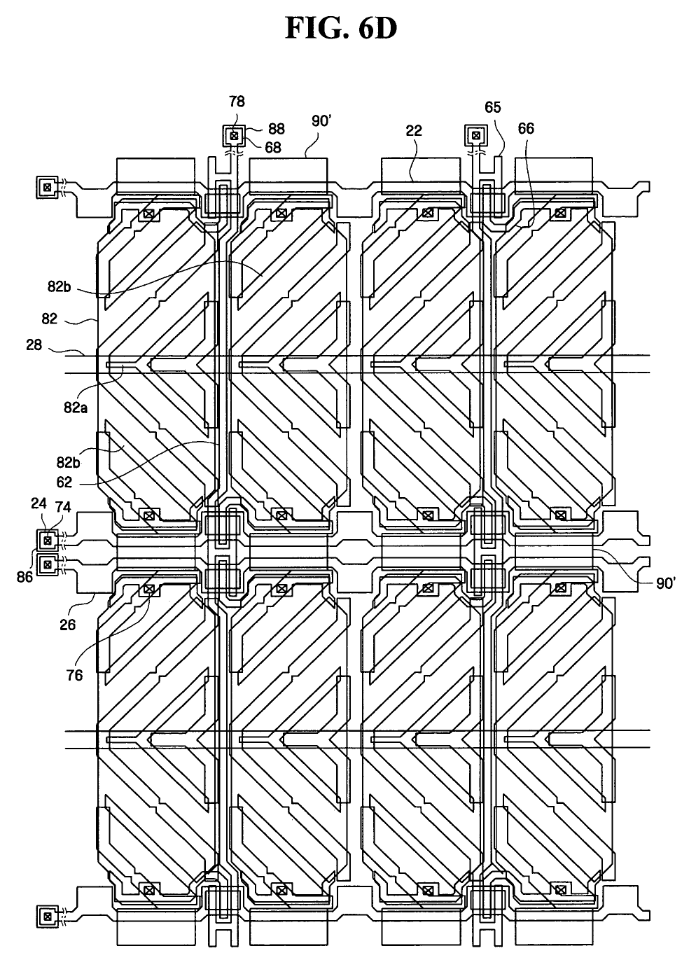

The structure of a second exemplary embodiment of a TFT array panel according to the present invention will be described in detail with reference to FIGS. 6A through 6D below.

FIG. 6A is a layout of a second exemplary embodiment of a TFT array panel according to the present invention, FIG. 6B is a cross section of the exemplary TFT array panel, taken along line VIb-VIb′ shown in FIG. 6A, FIG. 6C is an equivalent circuit diagram illustrating parasitic capacitances among a pixel electrode, a floating electrode, and a gate line included in the exemplary TFT array panel shown in FIG. 6A, and FIG. 6D illustrates a modified example of the exemplary TFT array panel shown in FIG. 6A. For clarity of the description, elements having the same functions as those shown in FIGS. 4A through 5D illustrating the first exemplary embodiment of the present invention are denoted by the same reference numerals and the description thereof will be omitted. The second exemplary embodiment of the TFT array panel according to the present invention shown in FIGS. 6A through 6D has substantially the same structure as that according to the first exemplary embodiment shown in FIGS. 4A through 5D, with the exception of the following features described below.

Referring to FIGS. 6A through 6D, a first floating electrode 90 is formed on the protective layer 70 and above the gate line 22 to be insulated from other wirings. The first floating electrode 90 may be formed on the same level from the same layer as the pixel electrode 82.

In addition, the first floating electrode 90 may be made using the same material as the pixel electrode 82, for example, a transparent conductive layer such as an ITO or IZO layer. That is, the first floating electrode 90 may be formed during a same manufacturing step as the pixel electrode 82.

Usually, parasitic capacitance occurs between the gate line 22 and the pixel electrode 82 adjacent to the gate line 22. Accordingly, when an overlay error occurs between the gate line 22 and the pixel electrode 82, for example, when the pixel electrode 82 is displaced up or down from the gate line 22, the parasitic capacitance between the pixel electrode 82 and the gate line 22 is different between two pixels adjacent around the gate line 22. In particular, in a TFT array panel in which the position of a switching element is different among pixels, the parasitic capacitance between the pixel electrode 82 and the gate line 22 is different according to whether the gate line 22 is located above or below the pixel electrode 82 in each pixel and this difference causes a difference in a kickback voltage. As a result, the visibility of the LCD may deteriorate.

However, in the second exemplary embodiment of the TFT array panel according to the present invention, parasitic capacitance occurs between the gate line 22 and the first floating electrode 90 formed on the gate line 22 and functions to suppress the change of parasitic capacitance between the gate line 22 and the pixel electrode 82 which may occur due to an overlay error so that influence of the change of the parasitic capacitance on each pixel is reduced.

Thus, the TFT array panel having the structure of the present invention can greatly reduce flickering.

Furthermore, the first floating electrode 90 may be formed to be wider than the gate line 22. Moreover, the first floating electrode 90 may be formed to overlap with the gate line 22 in the width direction of the gate line 22. Thus, overlay errors do not affect parasitic capacitance between the first floating electrode 90 and the gate line 22.

FIG. 6C is an equivalent circuit diagram illustrating parasitic capacitances among a pixel electrode, a floating electrode, and a gate line included in the exemplary TFT array panel shown in FIG. 6A.

Referring to FIG. 6C, a first pixel electrode 82′ and a second pixel electrode 82″ are disposed at opposite sides of the gate electrode 22. The first floating electrode 90 is disposed on the same level within the same layer as the first and second pixel electrodes 82′ and 82″ above the gate line 22. Parasitic capacitance between the gate line 22 and the first pixel electrode 82′ is represented with C₁. Parasitic capacitance between the gate line 22 and the second pixel electrode 82″ is represented with C₂. Parasitic capacitance between the gate line 22 and the first floating electrode 90 is represented with Cₐ. Parasitic capacitance between the first floating electrode 90 and the first pixel electrode 82′ is represented with C_{b}. Parasitic capacitance between the first floating electrode 90 and the second pixel electrode 82″ is represented with C_{c}. When the first floating electrode 90 completely overlaps with the gate line 22 in the width direction of the gate line 22, there is little change in an area in which the first floating electrode 90 and the gate line 22 face each other even if an overlay error occurs, and therefore, the parasitic capacitance Cₐ is almost constant. In addition, since a distance among the first pixel electrode 82′, the first floating electrode 90, and the second pixel electrode 82″ formed on the same level can always be kept constant because they may be formed within a same manufacturing step, the parasitic capacitance C_{b} and the parasitic capacitance C_{c} are almost constant.

In a conventional TFT array panel that does not include the first floating electrode 90, when an overlay error occurs between the gate line 22 and the pixel electrodes 82′ and 82″, a distance between the gate line 22 and the first pixel electrode 82′ is not the same as a distance between the gate line 22 and the second pixel electrode 82″ and thus the parasitic capacitance C₁ is different from the parasitic capacitance C₂. Therefore, kickback voltages of the pixel electrodes 82′ and 82″ arranged up and down the gate line 22 are different from each other, thereby causing flickering.

However, in the second exemplary embodiment of a TFT array panel having the first floating electrode 90 above the gate line 22 according to the present invention, parasitic capacitance between the gate line 22 and the first pixel electrode 82′ appears through parallel connection between the parasitic capacitance C₁ and a combination of the parasitic capacitances Cₐ, C_{b}, and C_{c}. As described above, since the parasitic capacitances Cₐ, C_{b}, and C_{c} are always constant, even if the parasitic capacitance C₁ changes, the parasitic capacitance between the gate line 22 and the first pixel electrode 82′ changes little and is minimized. In addition, parasitic capacitance between the gate line 22 and the second pixel electrode 82″ appears through parallel connection between the parasitic capacitance C₂ and a combination of the parasitic capacitances Cₐ, C_{b}, and C_{c} and changes little and is minimized. Accordingly, even if an overlay error occurs between the gate line 22 and the pixel electrodes 82′ and 82″, the parasitic capacitance occurring therebetween changes little and is minimized.

In the second exemplary embodiment of the present invention, since the drain electrode 66 is also formed to cross over the gate electrode 26, the TFT array panel of the second exemplary embodiment can achieve the same actions and effects as that of the first exemplary embodiment. However, the present invention is not restricted thereto, and in an alternative embodiment the drain electrode 66 may have a general structure.

FIG. 6D illustrates a modified example of the exemplary TFT array panel shown in FIG. 6A. Referring to FIG. 6D, a first floating electrode 90′ overlaps with two gate lines 22 of two respective pixel electrodes 82 adjacent in the column direction as shown in a central portion of FIG. 6D. In such a structure, even if an overlay error occurs between the gate electrode 22 and the pixel electrodes 82, parasitic capacitance therebetween changes little and is minimized.

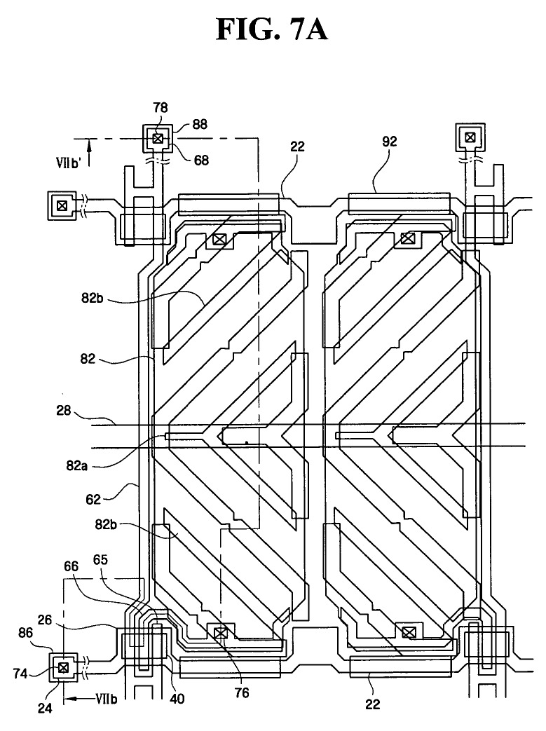

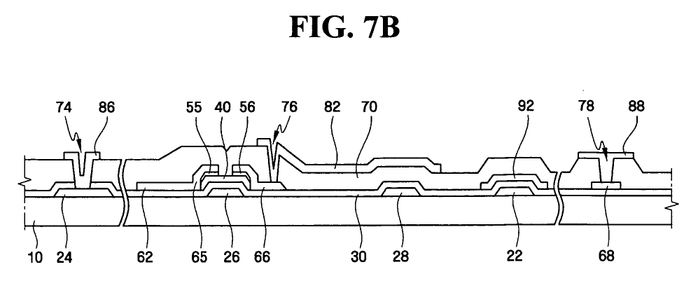

The structure of a third exemplary embodiment of a TFT array panel according to the present invention will be described in detail with reference to FIGS. 7A and 7B below.

FIG. 7A is a layout of a third exemplary embodiment of a TFT array panel according to the present invention, and FIG. 7B is a cross section of the exemplary TFT array panel, taken along line VIb-VIIb′ shown in FIG. 7A. For clarity of the description, elements having the same functions as those shown in FIGS. 4A through 5D illustrating the first exemplary embodiment of the present invention are denoted by the same reference numerals and the description thereof will be omitted. The third exemplary embodiment of the TFT array panel according to the present invention shown in FIGS. 7A and 7B has substantially the same structure as that according to the first exemplary embodiment shown in FIGS. 4A through 5D, with the exception of the following features described below.

Referring to FIGS. 7A and 7B, a second floating electrode 92 is formed on the gate insulating layer 30 above the gate line 22 to be insulated from other wirings. The second floating electrode 92 may be formed on the same level and within the same layer as the data line 62.

In addition, the second floating electrode 92 may be made using the same material as the data line 62, for example, a single layer formed of Al (or Al alloy) or a dual layer with an Al (or Al alloy) layer and a Mo (or Mo alloy) layer. Thus, the second floating electrode 92 may be formed during the same manufacturing step that forms the data line 62.

In general, parasitic capacitance occurs between the gate line 22 and the pixel electrode 82 adjacent to the gate line 22. Accordingly, when an overlay error occurs between the gate line 22 and the pixel electrode 82, for example, when the pixel electrode 82 is displaced up or down from the gate line 22, the parasitic capacitance between the pixel electrode 82 and the gate line 22 is different between two pixels adjacent around the gate line 22. In particular, in a TFT array panel in which the position of a switching element is different among pixels, the parasitic capacitance between the pixel electrode 82 and the gate line 22 is different according to whether the gate line 22 is located above or below the pixel electrode 82 in each pixel and this difference causes a difference in a kickback voltage. As a result, the visibility of the LCD may deteriorate.

However, similar to the above-described embodiments of the present invention, in the third exemplary embodiment of the TFT array panel according to the present invention, parasitic capacitance occurs between the gate line 22 and the second floating electrode 92 formed on the gate line 22 and functions to suppress the change of parasitic capacitance between the gate line 22 and the pixel electrode 82 which may occur due to an overlay error so that influence of the change of the parasitic capacitance on each pixel is reduced.

Thus, the TFT array panel having the structure incorporating the second floating electrode 92 can greatly reduce flickering.

Furthermore, the second floating electrode 92 may be formed to be wider than the gate line 22. Moreover, the second floating electrode 92 may be formed to completely overlap with the gate line 22 in the width direction of the gate line 22. Thus, an overlay error that may occur during a manufacturing method of the TFT array panel would not affect the parasitic capacitance between the second floating electrode 92 and the gate line 22, as the amount of overlap between the second floating electrode 92 and the gate line 22 would remain the same even if the second floating electrode 92 is shifted relative to the gate line 22.

In the third exemplary embodiment of the present invention, since the drain electrode 66 is also formed to cross over the gate electrode 26, the TFT array panel of the third exemplary embodiment can achieve the same actions and effects as that of the first exemplary embodiment. However, the present invention is not restricted thereto, and in an alternative embodiment the drain electrode 66 may have a general structure.

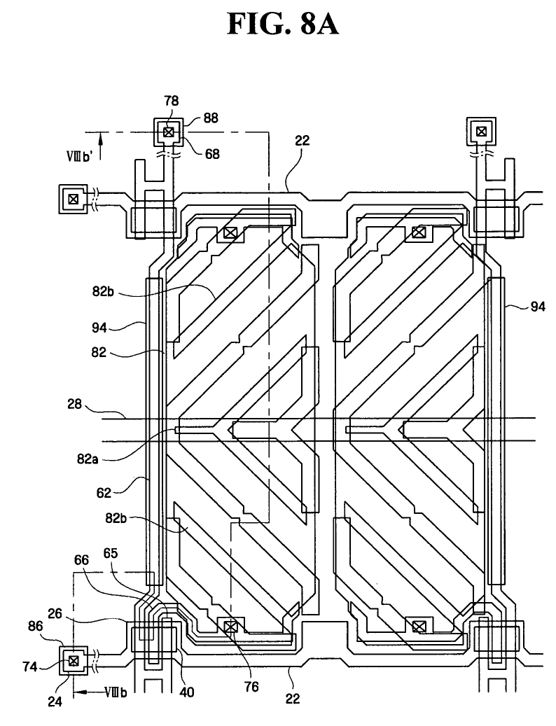

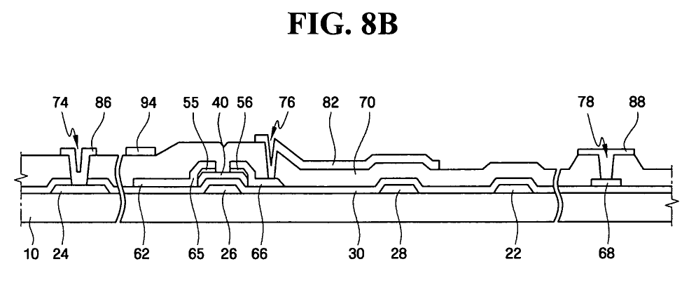

The structure of a fourth exemplary embodiment of a TFT array panel according to the present invention will be described in detail with reference to FIGS. 8A and 8B below. FIG. 8A is a layout of a fourth exemplary embodiment of a TFT array panel according to the present invention, and FIG. 8B is a cross section of the exemplary TFT array panel, taken along line VIIIb-VIIIb′ shown in FIG. 8A. For clarity of the description, elements having the same functions as those shown in FIGS. 4A through 5D illustrating the first exemplary embodiment of the present invention are denoted by the same reference numerals and the description thereof will be omitted. The fourth exemplary embodiment of the TFT array panel according to the present invention shown in FIGS. 8A and 8B has substantially the same structure as that according to the first exemplary embodiment shown in FIGS. 4A through 5D, with the exception of the following features described below.

Referring to FIGS. 8A and 8B, a third floating electrode 94 is formed on the protective layer 70 and above the data line 62 to be insulated from other wirings. The third floating electrode 94 may be formed on the same level and within the same layer as the pixel electrode 82.

In addition, the third floating electrode 94 may be made using the same material as the pixel electrode 82, for example, a transparent conductive layer formed of ITO or IZO. Thus, the third floating electrode 94 may be made during a same manufacturing step as the step where the pixel electrode 82 is formed.

In general, parasitic capacitance occurs between the data line 62 and the pixel electrode 82 adjacent to the data line 62. Accordingly, when an overlay error occurs between the data line 62 and the pixel electrode 82, for example, when the pixel electrode 82 is displaced left or right from the data line 62, the parasitic capacitance between the pixel electrode 82 and the data line 62 is different between two pixels adjacent around the data line 62. In particular, in a TFT array panel in which the position of a switching element is different among pixels, the parasitic capacitance between the pixel electrode 82 and the data line 62 is different according to whether the data line 62 is located in the left or right of the pixel electrode 82 in each pixel and this difference causes a difference in a kickback voltage. As a result, the visibility of the LCD may deteriorate.

However, similar to the above-described embodiments of the present invention, in the fourth exemplary embodiment of the TFT array panel according to the present invention, parasitic capacitance occurs between the data line 62 and the third floating electrode 94 formed on the data line 62 and functions to suppress the change of parasitic capacitance between the data line 62 and the pixel electrode 82 which may occur due to an overlay error so that influence of the change of the parasitic capacitance on each pixel is reduced.

Thus, the TFT array panel having such structure can greatly reduce flickering.

Furthermore, the third floating electrode 94 may be formed to be wider than the data line 62. Moreover, the third floating electrode 94 may be formed to completely overlap with the data line 62 in the width direction of the data line 62. Thus, an overlay error that may occur during a manufacturing method of the TFT array panel would not affect the parasitic capacitance between the third floating electrode 94 and the data line 62, as the amount of overlap between the third floating electrode 94 and the data line 62 would remain the same even if the third floating electrode 94 is shifted relative to the data line 22.

In the fourth exemplary embodiment of the present invention, since the drain electrode 66 is also formed to cross over the gate electrode 26, the TFT array panel of the fourth exemplary embodiment can achieve the same actions and effects as that of the first exemplary embodiment. However, the present invention is not restricted thereto, and in an alternative embodiment the drain electrode 66 may have a general structure.

To realize a high-resolution LCD, the above-described embodiments of the present invention provide TFT array panels that can secure a pitch between data lines by doubling the number of gate lines and decreasing the number of data lines by half. However, the present invention is not restricted thereto and also provides a TFT array panel employing pattern vertical alignment (“PVA”) in which cut patterns are formed in an electrode as a means for achieving a wide viewing angle by controlling the slanting direction of a liquid crystal using a slit and a TFT array panel employing multi-domain vertical alignment (“MVA”) controlling the slanting direction of a liquid crystal using a protrusion or a slit in order to secure a wide viewing angle.

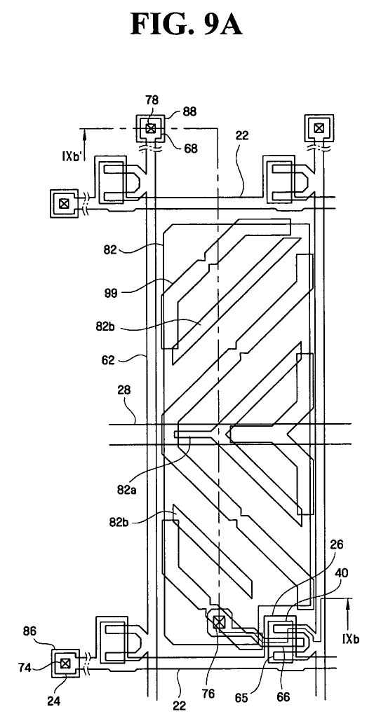

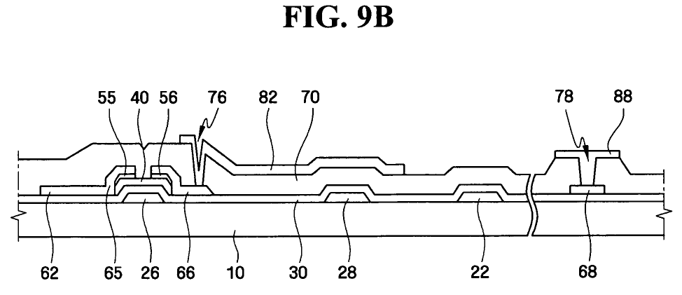

Hereinafter, TFT array panels employing the PVA or the MVA according to various embodiments of the present invention will be described with reference to FIGS. 9A through 12B.

The structure of a fifth exemplary embodiment of a TFT array panel according to the present invention will be described in detail with reference to FIGS. 9A and 9B below. FIG. 9A is a layout of a fifth exemplary embodiment of a TFT array panel according to the present invention, and FIG. 9B is a cross section of the exemplary TFT array panel, taken along line IXb-IXb′ shown in FIG. 9A. For clarity of the description, elements having the same functions as those shown in FIGS. 4A through 5D illustrating the first exemplary embodiment of the present invention are denoted by the same reference numerals and the description thereof will be omitted. The fifth exemplary embodiment of the TFT array panel according to the present invention shown in FIGS. 9A and 9B has substantially the same structure as that according to the first exemplary embodiment shown in FIGS. 4A through 5D, with the exception of the following features described below.

The TFT array panel of the fifth exemplary embodiment includes a single data line and a single gate line for a single pixel area. Similar to the TFT array panel of the first exemplary embodiment, since the TFT array panel of the fifth exemplary embodiment includes the drain electrode 66 formed to cross over the gate electrode 26, the TFT array panel of the fourth exemplary embodiment can achieve the same actions and effects as that of the first exemplary embodiment. The drain electrode 66 in this embodiment extends substantially parallel to the gate line 22 as opposed to substantially perpendicular to the gate line 22 as in the first exemplary embodiment. In either example, however, since the drain electrode 66 crosses over the gate electrode 26, extending over and past opposite sides of the gate electrode 26, the parasitic capacitance almost does not change in each pixel even if an overlay error occurs between a gate wiring and a data wiring.

The above-described embodiments of the present invention provide TFT array panels that can secure a wide viewing angle by employing PVA controlling the slanting direction of a liquid crystal using a slit. However, the present invention is not restricted thereto and also provides a TFT array panel employing multi-domain vertical alignment (MVA) controlling the slanting direction of a liquid crystal using a dielectric protrusion or slit in order to secure a wide viewing angle.

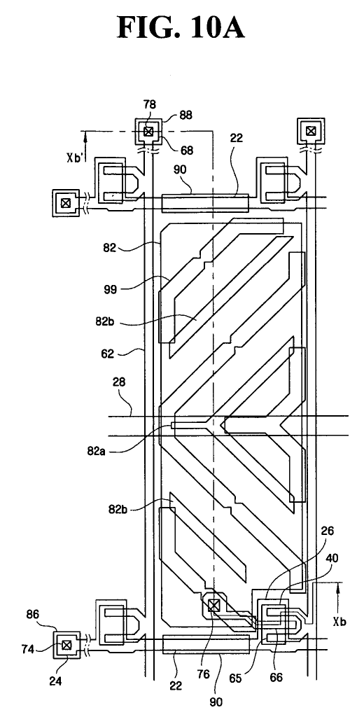

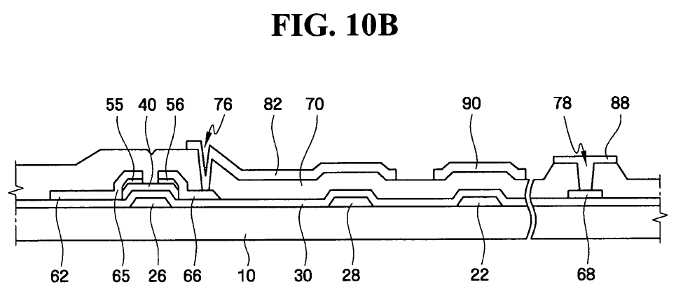

The structure of a sixth exemplary embodiment of a TFT array panel according to the present invention will be described in detail with reference to FIGS. 10A and 10B below. FIG. 10A is a layout of a sixth exemplary embodiment of a TFT array panel according to the present invention, and FIG. 10B is a cross section of the exemplary TFT array panel, taken along line Xb-Xb′ shown in FIG. 10A. The TFT array panel according to the sixth exemplary embodiment of the present invention shown in FIGS. 10A and 10B has substantially the same structure as that according to the second exemplary embodiment shown in FIGS. 6A through 6D, with the exception that the exemplary TFT array panel of the sixth exemplary embodiment includes a single data line and a single gate line for a single pixel area. For clarity of the description, elements having the same functions as those shown in FIGS. 4A through 5D illustrating the first exemplary embodiment of the present invention are denoted by the same reference numerals and the description thereof will be omitted.

Similar to the exemplary TFT array panel of the second exemplary embodiment, the TFT array panel of the sixth exemplary embodiment includes the first floating electrode 90 formed on the protective layer 70 and above the gate line 22 to be insulated from other wirings, thereby increasing visibility. Here, the first floating electrode 90 may be formed on the same level and within the same layer as the pixel electrode 82. In addition, since the exemplary TFT array panel of the sixth exemplary embodiment includes the drain electrode 66 formed to cross over the gate electrode 26, the TFT array panel of the sixth exemplary embodiment can achieve the same actions and effects as that of the first exemplary embodiment. However, the present invention is not restricted thereto, and in an alternative embodiment the drain electrode 66 may have a general structure.

The above-described embodiments of the present invention provide TFT array panels that can secure a wide viewing angle by employing PVA controlling the slanting direction of a crystal liquid using a slit. However, the present invention is not restricted thereto and also provides a TFT array panel employing multi-domain vertical alignment (MVA) controlling the slanting direction of a liquid crystal using a dielectric protrusion or slit in order to secure a wide viewing angle.

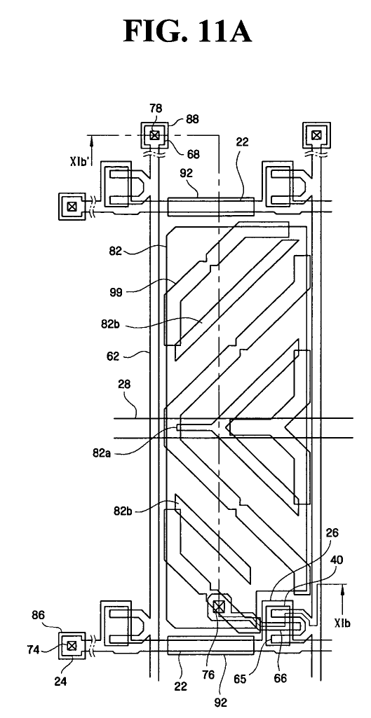

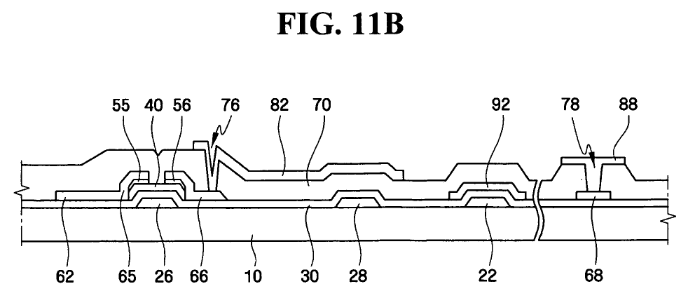

The structure of a seventh exemplary embodiment of a TFT array panel according to the present invention will be described in detail with reference to FIGS. 11A and 11B below. FIG. 11A is a layout of a seventh exemplary embodiment of a TFT array panel according to the present invention, and FIG. 11B is a cross section of the exemplary TFT array panel, taken along line XIb-XIb′ shown in FIG. 11A. For clarity of the description, elements having the same functions as those shown in FIGS. 7A and 7B illustrating the third exemplary embodiment of the present invention are denoted by the same reference numerals and the description thereof will be omitted.

The seventh exemplary embodiment of the TFT array panel according to the present invention shown in FIGS. 11A and 11B has substantially the same structure as that according to the third exemplary embodiment shown in FIGS. 7A and 7B, with the exception that the TFT array panel of the seventh exemplary embodiment includes a single data line and a single gate line for a single pixel area.

Similar to the TFT array panel of the third exemplary embodiment, the TFT array panel of the seventh exemplary embodiment includes the second floating electrode 92 formed on the gate insulating layer 30 and above the gate line 22 to be insulated from other wirings, thereby increasing visibility. Here, the second floating electrode 92 may be formed on the same level and within the same layer as the data line 62. In addition, since the TFT array panel of the seventh exemplary embodiment includes the drain electrode 66 formed to cross over the gate electrode 26, the TFT array panel of the seventh exemplary embodiment can achieve the same actions and effects as that of the third exemplary embodiment. However, the present invention is not restricted thereto, and in an alternative embodiment the drain electrode 66 may have a general structure.

The above-described embodiments of the present invention provide TFT array panels that can secure a wide viewing angle by employing PVA controlling the slanting direction of a liquid crystal using a slit. However, the present invention is not restricted thereto and also provides a TFT array panel employing multi-domain vertical alignment (MVA) controlling the slanting direction of a liquid crystal using a dielectric protrusion or slit in order to secure a wide viewing angle.

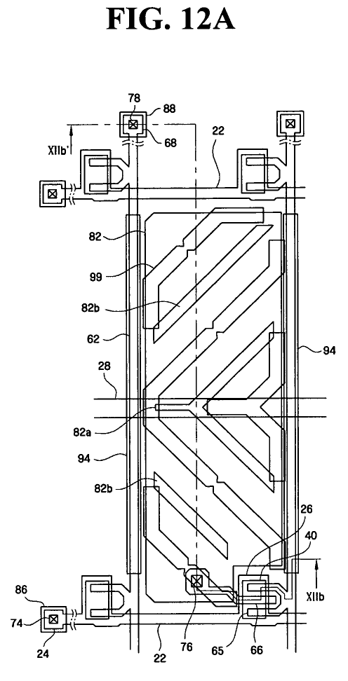

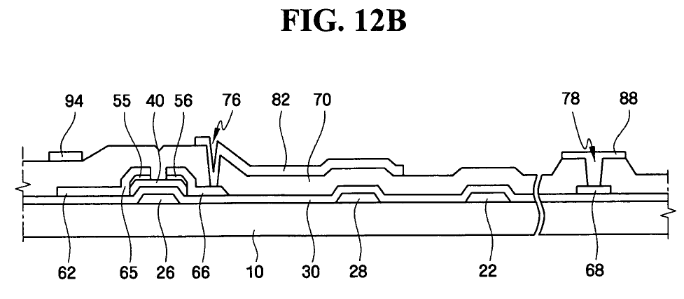

The structure of an eighth exemplary embodiment of a TFT array panel according to the present invention will be described in detail with reference to FIGS. 12A and 12B below. FIG. 12A is a layout of an eighth exemplary embodiment of a TFT array panel according to the present invention, and FIG. 12B is a cross section of the exemplary TFT array panel, taken along line XIIb-XIIb′ shown in FIG. 12A. The eighth exemplary embodiment of the TFT array panel according to the present invention shown in FIGS. 12A and 12B has substantially the same structure as that according to the fourth exemplary embodiment shown in FIGS. 8A and 8B, with the exception that the TFT array panel of the eighth exemplary embodiment includes a single data line and a single gate line for a single pixel area.

Similar to the TFT array panel of the fourth exemplary embodiment, the TFT array panel of the eighth exemplary embodiment includes the third floating electrode 94 formed on the protective layer 70 and above the data line 62 to be insulated from other wirings, thereby increasing visibility. Here, the third floating electrode 94 may be formed on the same level and within the same layer as the pixel electrode 82. In addition, since the TFT array panel of the eighth exemplary embodiment includes the drain electrode 66 formed to cross over the gate electrode 26, the TFT array panel of the eighth exemplary embodiment can achieve the same actions and effects as that of the fourth exemplary embodiment. However, the present invention is not restricted thereto, and in an alternative embodiment the drain electrode 66 may have a general structure.

The above-described embodiments of the present invention provide TFT array panels that can secure a wide viewing angle by employing PVA controlling the slanting direction of a liquid crystal using a slit. However, the present invention is not restricted thereto and also provides a TFT array panel employing multi-domain vertical alignment (MVA) controlling the slanting direction of a liquid crystal using a dielectric protrusion or slit in order to secure a wide viewing angle.

A method of reducing flickering in a display panel when a distance between adjacent pixel electrodes and a data line or a gate line interposed between the pixel electrodes is not constant, such as when an overlay error occurs during a manufacturing of the TFT array panel, is thus made possible by maintaining uniform parasitic capacitance in a thin film transistor array panel of the display panel. In some exemplary embodiments, maintaining uniform parasitic capacitance includes completely overlapping a drain electrode within the thin film transistor array panel past first and second opposite sides of a gate electrode of the gate line. In other exemplary embodiments, maintaining uniform parasitic capacitance includes providing a floating electrode on and insulated from the gate line, the floating electrode completely overlapping with the gate line in a width direction of the gate line. In still other exemplary embodiments, maintaining uniform parasitic capacitance includes providing a floating electrode on and insulated from the data line, the floating electrode completely overlapping with the data line in a width direction of the gate line.

Although the exemplary embodiments of the present invention have been described separately, the present invention is not restricted thereto, and a combination of one or more embodiments may be used to implement a TFT array panel.

According to the TFT array panel, the parasitic capacitance is kept the same among the pixels or the change of the parasitic capacitance is minimized, thereby preventing flickering and increasing the picture quality.

In concluding the detailed description, those skilled in the art will appreciate that many variations and modifications can be made to the preferred embodiments without substantially departing from the principles of the present invention. Therefore, the disclosed preferred embodiments of the invention are used in a generic and descriptive sense only and not for purposes of limitation. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A thin film transistor array panel comprising:
a gate line disposed on an insulating substrate and extending in a row direction, the gate line having a gate electrode;
a semiconductor layer disposed above and insulated from the gate electrode;
a data line having a source electrode at least partially overlapping with the semiconductor layer, the data line extending in a column direction, and the data line crossing the gate line and insulated from the gate line;
a drain electrode facing the source electrode around the gate electrode, the drain electrode at least partially overlapping with the semiconductor layer, and the drain electrode crossing over the gate electrode; and
a pixel electrode disposed above and insulated from the gate line, the semiconductor layer, and the data line, the pixel electrode electrically connected to the drain electrode, the pixel electrode divided into a plurality of small domains by a domain divider.

2. The thin film transistor array panel of claim 1, wherein a parasitic capacitance between the drain electrode and the gate electrode is maintained constant even when a parasitic capacitance between two adjacent pixel electrodes and a data or gate line interposed between the two adjacent pixel electrodes varies.

3. The thin film transistor array panel of claim 1, wherein the drain electrode extends past first and second opposite sides of the gate electrode for accommodating an overlay error occurring during a manufacturing of the thin film transistor array panel.

4. The thin film transistor array panel of claim 1, wherein parasitic capacitance occurring between the drain electrode and the gate electrode suppresses a change in parasitic capacitance between the gate line and the pixel electrode due to an overlay error.

5. The thin film transistor array panel of claim 1, wherein the data line branches into source electrodes for at least two pixel electrodes, respectively, arranged in the row direction, and the gate line includes a pair of an odd gate line and an even gate line providing gate signals to gate electrodes corresponding to the source electrodes, respectively.

6. The thin film transistor array panel of claim 5, wherein a source electrode for a first pixel is positioned on a first side of the data line, and a source electrode for a second pixel is positioned on a second side of the data line.

7. The thin film transistor array panel of claim 1, further comprising a floating electrode disposed above and insulated from the gate line, the floating electrode at least partially overlapping with the gate line.

8. The thin film transistor array panel of claim 7, wherein a parasitic capacitance between the floating electrode and the gate line is maintained constant when an overlay error occurs during a manufacturing of the thin film transistor array panel.

9. The thin film transistor array panel of claim 7, wherein the floating electrode is disposed on a same level within the thin film transistor array panel as the pixel electrode and the floating electrode is made using a same material as the pixel electrode.

10. The thin film transistor array panel of claim 9, wherein the data line branches into source electrodes for at least two pixel electrodes, respectively, arranged in the row direction;
the gate line includes a pair of an odd gate line and an even gate line providing gate signals to gate electrodes corresponding to the source electrodes, respectively; and
the floating electrode overlaps with two gate lines of respective pixel electrodes adjacent in a column direction.

11. The thin film transistor array panel of claim 7, wherein the floating electrode is disposed on a same level within the thin film transistor array panel as the data line and the floating electrode is made using a same material as the data line.

12. The thin film transistor array panel of claim 7, wherein the floating electrode completely overlaps with the gate line in a width direction of the gate line.

13. The thin film transistor array panel of claim 1, further comprising a floating electrode disposed above and insulated from the data line, the floating electrode at least partially overlapping with the data line.

14. The thin film transistor array panel of claim 13, wherein a parasitic capacitance between the floating electrode and the data line is maintained constant when an overlay error occurs during a manufacturing of the thin film transistor array panel.

15. The thin film transistor array panel of claim 13, wherein the floating electrode is disposed on a same level within the thin film transistor array panel as the pixel electrode and the floating electrode made using a same material as the pixel electrode.

16. The thin film transistor array panel of claim 13, wherein the floating electrode completely overlaps with the data line in a width direction of the data line.

17. The thin film transistor array panel of claim 1, wherein the domain divider is a cut pattern formed in the pixel electrode.

18. The thin film transistor array panel of claim 1, wherein the domain divider is a dielectric protrusion formed on the pixel electrode.

19. The thin film transistor array panel of claim 1, wherein a parasitic capacitance of pixels within the thin film transistor array panel is maintained at least substantially constant when a distance between adjacent pixel electrodes and a data line or gate line interposed between the pixel electrodes is not constant.

20. A thin film transistor array panel comprising:
a gate line disposed on an insulating substrate and extending in a row direction, the gate line having a gate electrode;
a semiconductor layer disposed above and insulated from the gate electrode;
a data line having a source electrode at least partially overlapping with the semiconductor layer, the data line extending in a column direction, and the data line crossing the gate line and insulated from the gate line;
a drain electrode facing the source electrode around the gate electrode, the drain electrode at least partially overlapping with the semiconductor layer;
a pixel electrode disposed above and insulated from the gate line, the semiconductor layer, and the data line, the pixel electrode electrically connected to the drain electrode, and the pixel electrode divided into a plurality of small domains by a domain divider; and
a floating electrode disposed above and insulated from the gate line, and the floating electrode at least partially overlapping with the gate line.

21. The thin film transistor array panel of claim 20, wherein the floating electrode is disposed on a same level as the pixel electrode and the floating electrode is made using a same material as the pixel electrode.

22. The thin film transistor array panel of claim 21, wherein the data line branches into source electrodes for at least two pixel electrodes, respectively, arranged in the row direction; the gate line includes a pair of an odd gate line and an even gate line providing gate signals to gate electrodes corresponding to the source electrodes, respectively; and the floating electrode overlaps with two gate lines of respective pixel electrodes adjacent in a column direction.

23. The thin film transistor array panel of claim 20, wherein the floating electrode is disposed on a same level as the data line and the floating electrode is made using a same material as the data line.

24. The thin film transistor array panel of claim 20, wherein the floating electrode completely overlaps with the gate line in a width direction of the gate line.

25. The thin film transistor array panel of claim 20, wherein the drain electrode crosses over the gate electrode.

26. The thin film transistor array panel of claim 20, wherein the data line branches into source electrodes for at least two pixel electrodes, respectively, arranged in the row direction, and the gate line includes a pair of an odd gate line and an even gate line providing gate signals to gate electrodes corresponding to the source electrodes, respectively.

27. The thin film transistor array panel of claim 20, wherein the domain divider is a cut pattern formed in the pixel electrode.

28. The thin film transistor array panel of claim 20, wherein the domain divider is a dielectric protrusion formed on the pixel electrode.

29. A thin film transistor array panel comprising:
a gate line disposed on an insulating substrate and extending in a row direction, the gate line having a gate electrode;
a semiconductor layer disposed above and insulated from the gate electrode;
a data line having a source electrode at least partially overlapping with the semiconductor layer, the data line extending in a column direction, and the data line crossing the gate line and being insulated from the gate line;
a drain electrode facing the source electrode around the gate electrode, the drain electrode at least partially overlapping with the semiconductor layer;
a pixel electrode disposed above and insulated from the gate line, the semiconductor layer, and the data line, the pixel electrode electrically connected to the drain electrode, and the pixel electrode divided into a plurality of small domains by a domain divider; and
a floating electrode disposed above and insulated from the data line and the floating electrode at least partially overlapping with the data line.

30. The thin film transistor array panel of claim 29, wherein the floating electrode is disposed on a same level as the pixel electrode and the floating electrode is made using a same material as the pixel electrode.

31. The thin film transistor array panel of claim 29, wherein the floating electrode completely overlaps with the gate line in a width direction of the gate line.

32. The thin film transistor array panel of claim 29, wherein the drain electrode crosses over the gate electrode.

33. The thin film transistor array panel of claim 29, wherein the data line branches into source electrodes for at least two pixel electrodes, respectively, arranged in the row direction; and the gate line includes a pair of an odd gate line and an even gate line providing gate signals to gate electrodes corresponding to the source electrodes, respectively.

34. The thin film transistor array panel of claim 29, wherein the domain divider is a cut pattern formed in the pixel electrode.

35. The thin film transistor array panel of claim 29, wherein the domain divider is a dielectric protrusion formed on the pixel electrode.

36. A method of reducing flickering in a display panel when a distance between adjacent pixel electrodes and a data line or a gate line interposed between the pixel electrodes is not constant, the method comprising:
maintaining uniform parasitic capacitance in a thin film transistor array panel of the display panel.

37. The method of claim 36, wherein maintaining uniform parasitic capacitance comprises completely overlapping a drain electrode within the thin film transistor array panel past first and second opposite sides of a gate electrode of the gate line.

38. The method of claim 36, wherein maintaining uniform parasitic capacitance comprises providing a floating electrode on and insulated from the gate line, the floating electrode completely overlapping with the gate line in a width direction of the gate line.

39. The method of claim 36, wherein maintaining uniform parasitic capacitance comprises providing a floating electrode on and insulated from the data line, the floating electrode completely overlapping with the data line in a width direction of the gate line.
